(19) United States
(12) Patent Application Publication
(10) Pub. No.: US 2007/0089702 A1
(43) Pub. Date: Apr. 26, 2007

(54) Three cycle internal combustion engine

(76) Inventor: Anton Perich, New York, NY (US)

Correspondence Address: Charles E. Temko, 22 Marion Road, Westport, CT, 06880, US

(21) Appl. No.: 11/256,612

(22) Filed: Oct. 24, 2005

(51) Int. Cl. F02B 53/00; F01C 9/00; F02B 75/02

(52) U.S. Cl. 123/243; 123/64; 123/18 R

(57) ABSTRACT

An internal combustion engine having an intake cycle, a power cycle, and an exhaust cycle performed over 360-degree rotation of a power output shaft. The intake cycle extends over a first 90 degrees of rotation. The power cycle extends over a following 90 degrees of rotation. A final 180 degrees of rotation performs an exhaust cycle. In a first embodiment, the device includes a conventional cylinder, piston, connecting rod and crank shaft. In a second embodiment a fixed element defines a chamber wherein an offset rotating element includes a vane which expands to maintain contact with an inner surface of the fixed element.

### BACKGROUND OF THE INVENTION

This invention relates generally to the field of internal combustion engines, and more particularly to a device of this type which is particularly adapted to use low grade fuels in lieu of high octane fuels which have now become very expensive.

Two-cycle and four-cycle engines are very well known in the art. In the two-cycle engine, fuel intake commences when the piston is at its uppermost position within the cylinder following which a power stroke of 180 degrees progresses as the piston moves from its top position to the bottom position. At this point, the piston passes a port which vents the remaining burnt gases, and as the piston rotates an additional 180 degrees to its top position, the remaining exhaust gases are combined with fresh ambient air which is compressed as the piston moves to its top position. Thus, there is one power stroke for each 360 degree rotation of the crank shaft. In the four-cycle engine, the first 180 degrees are employed for intake of fuel, following which the next 180 degrees compresses this fuel as the piston returns to its top position. There then follows a power stroke in which the compressed fuel is ignited and the piston is again driven to its lowermost position. The final 180 degrees is used to exhaust the remaining spent gases, following which another two-revolution cycle commences. In the case of the two-cycle engine, a substantial amount of power is derived from a relatively small engine because there is one power stroke for each revolution of the crank shaft. In the four-cycle engine, only one of the strokes is a power stroke, but because more fuel is injected and it is compressed to a greater degree, the output of the four-cycle is quite efficient. Particularly with latest designs, a rather high octane fuel rating is required to prevent engine knock.

With rapidly increasing fuel costs, there arises a need for an engine which is capable of reasonable power output and which may use fuels of relatively lower octane which are considerably less costly.

### SUMMARY OF THE INVENTION

Briefly stated, the invention contemplates the provision of an improved internal combustion engine which provides one power stroke for each revolution of the crank shaft, as in a two-cycle engine, and which commences burning fuel substantially at atmospheric pressure relying only on the expansion of burning gaseous fuel to produce power. Thus, while the effective compression is lower than in a four-cycle engine, the fuel employed may be of considerably lower octane rating, which is available at considerably lower cost. Examples of such fuel are kerosene, and No. 2 fuel oil.

### BRIEF DESCRIPTION OF THE DRAWINGS

In the drawings, to which reference will be made in the specification, similar reference characters have been employed to designate corresponding parts throughout the several views.

FIG. 1 is a schematic sectional view illustrating a first embodiment of the invention.

FIG. 2 is a corresponding schematic sectional view of the first embodiment showing certain of the component parts in altered relative position.

FIG. 3 is a schematic sectional view of the first embodiment showing certain of the component parts in further altered relative position.

FIG. 4 is a schematic sectional view of a second embodiment of the invention.

FIG. 5 is a schematic sectional view of the second embodiment at right angles to that seen in FIG. 4.

FIG. 6 is a schematic sectional view of a third embodiment of the invention.

FIG. 7 is a schematic sectional view of the third embodiment as seen at right angles to that seen in FIG. 6.

### DETAILED DESCRIPTION OF THE DISCLOSED EMBODIMENTS

In accordance with the first embodiment of the invention, the device, generally indicated by reference character 10, includes a sleeved cylinder 11 defining an elongated chamber 12. A closed upper end 13 includes an intake valve 14. A sliding piston 15 includes a connecting pin 16 supporting a connecting rod 17, a lower end 18 of which is connected to a crank 19 of a crank shaft 20 in known manner.

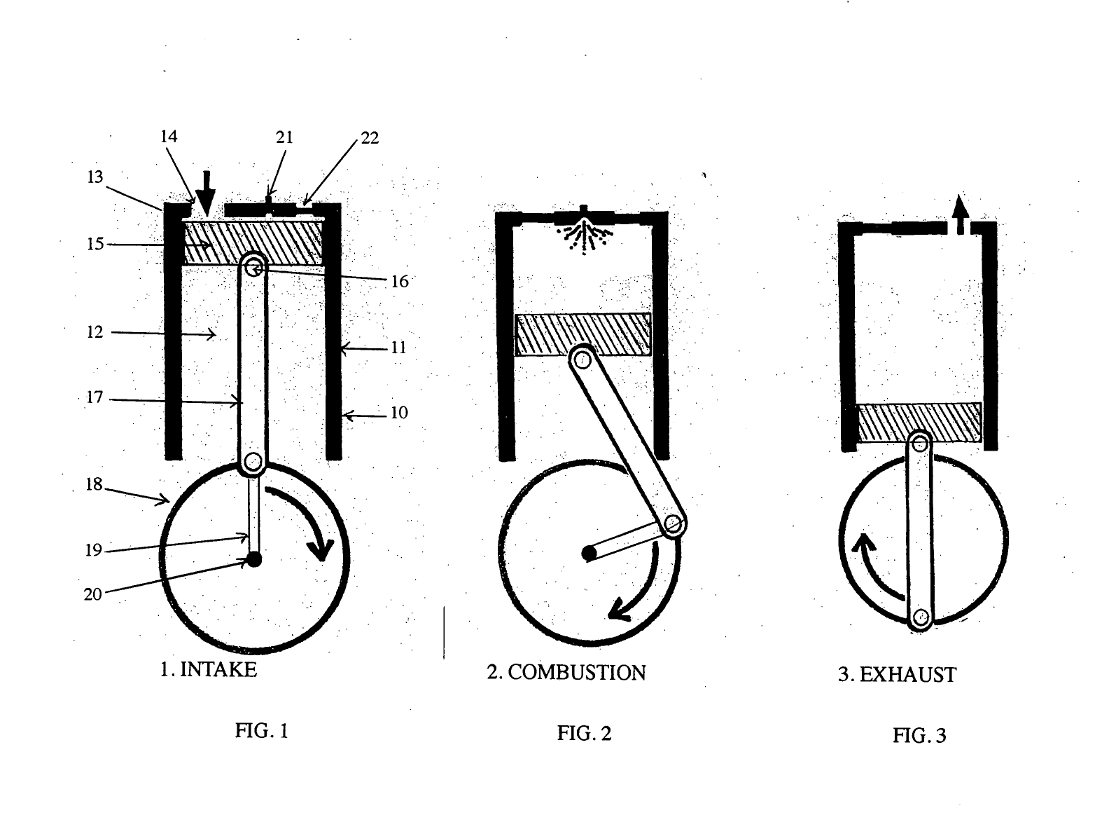

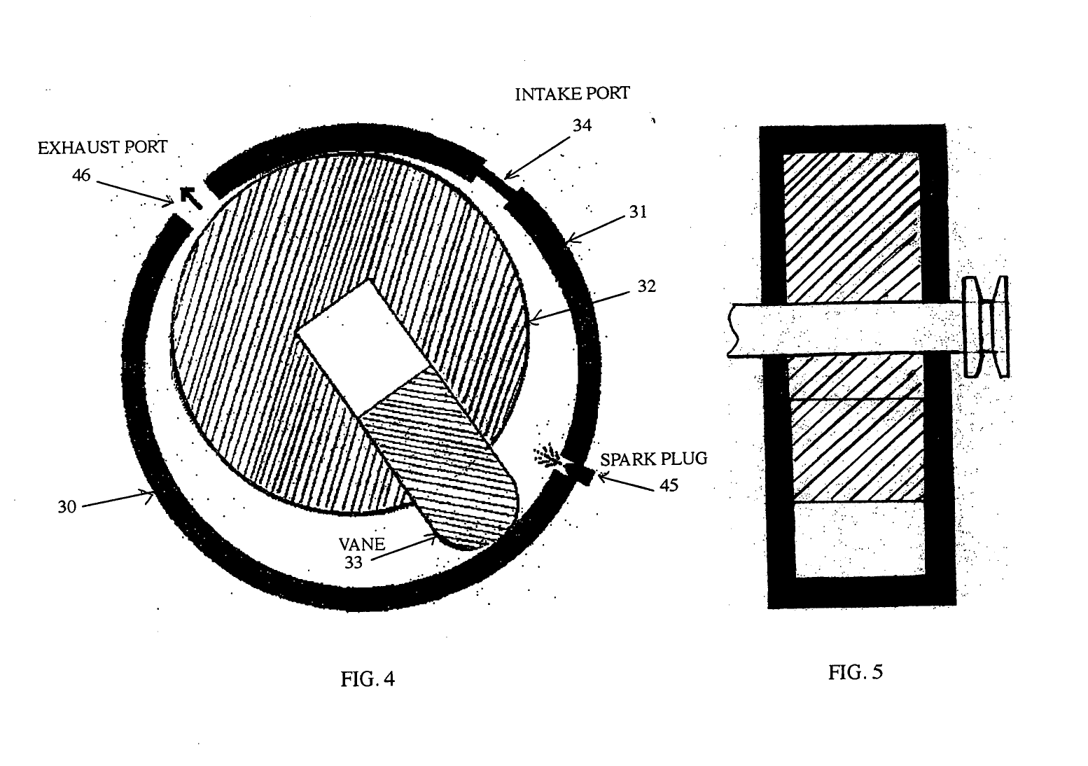

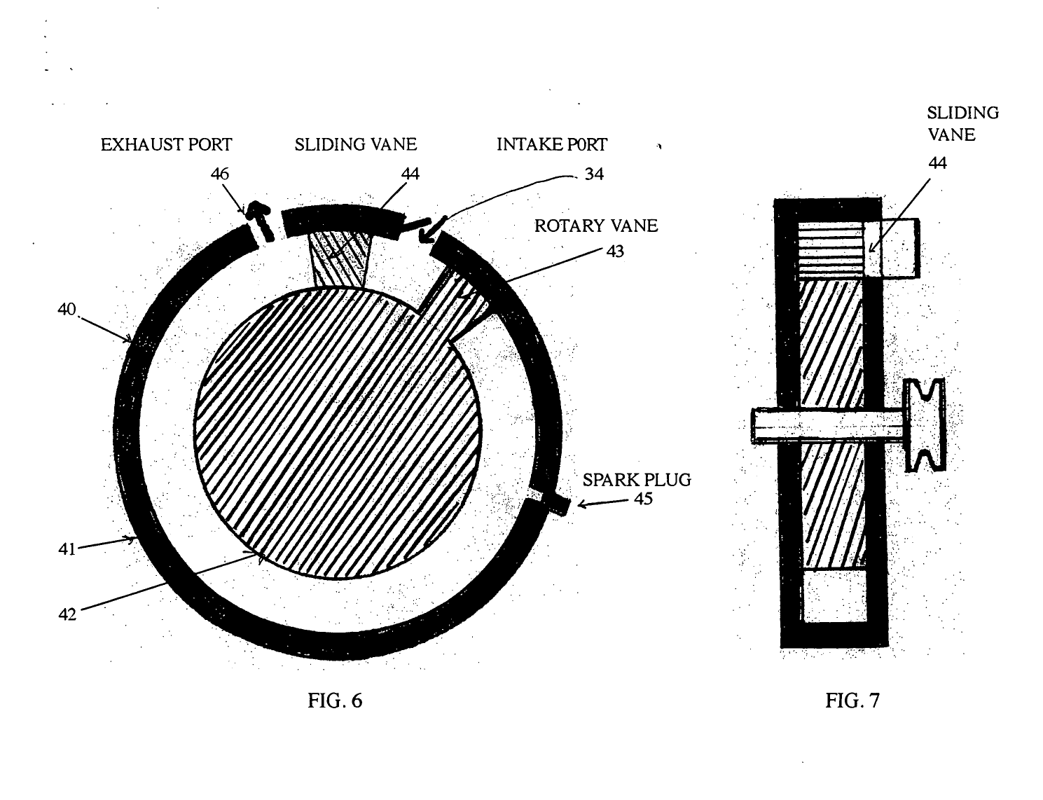

Operation of the device will be understood by a comparison of FIGS. 1, 2, and 3 in the drawing. A first cycle commences with a 90 degree rotation of the crank shaft from top or upper piston location, during which time the intake valve is open and fuel is inducted substantially at atmospheric pressure. By the time the crank shaft has reached 90 degree rotation, the intake valve has been closed and the inducted fuel fired by a spark plug 21 The entrapped fuel commences burning at atmospheric pressure, and continues through the next 90 degree rotation of the crank shaft until the piston reaches its bottom excursion. During this 90 degree rotation, the crank shaft delivers power.

The next 180 degree rotation of the crank shaft involves the return of the piston to its uppermost excursion, during which time the spent fuel is exhausted through an exhaust port 22 known manner, at which time the complete cycle commences again. There is thus a power stroke for each rotation of the crank shaft, although considerably less power is developed because of the shortness of the power stroke and the fact that combustion commences substantially at atmospheric pressure.

Turning now to the second embodiment of the invention (FIG. 4), the device, generally indicated by reference character 30 includes a fixed cylinder 31 and a rotating element 32. The element 32 includes a reciprocating vane which oscillates with each 360 degrees of rotation to execute the same three-cycle function as in the first embodiment. The intake and exhaust functions are performed in a manner similar to that of a two-cycle engine, while the rotating element eliminates the need for a crank shaft and cam shaft. Power output will be directly related to the size of the device.

It may thus be seen that I have invented novel and highly useful improvements in internal combustion engines, in which the devices are particularly adapted for use with fuels of relatively low grade by limiting the amount of gaseous expansion during the power stroke. Valving functions may be performed in known manner, using ports which are uncovered by piston movement, or known poppet valves may be used which are operated by crank shaft rotation, with or without a cam shaft.

I wish it to be understood that I do not consider the invention to be limited to the details illustrated and described in the specification, for obvious modifications will occur to those skilled in the art to which the invention pertains.

I claim:

1. A three-cycle internal combustion engine having a rotating output shaft; said engine having a first intake cycle extending over a first 90-degree rotation of said shaft, a second combustion cycle extending over a second 90-degree rotation of said shaft, and a third exhaust cycle extending over a subsequent 180-degree rotation of said shaft.

2. A device in accordance with claim 1, said engine including a cylinder sleeve, a piston slidably disposed within said sleeve, a connecting rod pivotally associated with said piston at one end thereof, and a crank shaft interconnected to a second end of said connecting rod.

3. A device in accordance with claim 1, including a fixed chamber, a rotating element disposed within said chamber, said rotating element including a reciprocating vane resiliently contacting an inner surface of said fixed element.
